(19) United States
(12) Patent Application Publication
(10) Pub. No.: US 2017/0047834 A1
(43) Pub. Date: Feb. 16, 2017

(54) Brushless Motor and System Thereof

(71) Applicant: Foster Assets Corporation, Kowloon (HK)

(72) Inventor: Yet Chan, Kowloon (HK)

(73) Assignee: Foster Assets Corporation, Kowloon (HK)

(21) Appl. No.: 15/307,350

(22) PCT Filed: Apr. 28, 2014
(86) PCT No.: PCT/CN2014/076393

§ 371 Date: Oct. 27, 2016

(51) Int. Cl. H02K 21/12; H02K 11/215; H02K 11/33; H02J 7/00; H02K 1/08; H02K 3/18

(52) U.S. Cl. CPC H02K 21/12; H02K 1/08; H02K 3/18; H02K 11/33; H02J 7/0013; H02K 11/215

(57) ABSTRACT

A brushless motor controller system includes a brushless motor (201) which further contains a rotor (24) and a stator (22), a plurality of independent motor controllers (203), a plurality of batteries (204), and a plurality of battery chargers (205). The stator (22) of the brushless motor (201) has a plurality of salient poles (32). A plurality of coils are wound on the salient poles (32) such that on each of the salient poles (32) there is wound different groups of windings electrically isolated from each other. The plurality of independent motor controllers (203) each corresponds and is electrically connected to one of the groups of windings on one of the salient poles (32) of the brushless motor (201). The plurality of batteries (204) each is connected to a corresponding one of the independent motor controllers (203) to provide electrical power thereto. The plurality of battery chargers (205) each is connected to el a corresponding one of the batteries (204). The plurality of independent motor controllers (203) each is adapted to power and control a corresponding one of the groups of coils on one of the salient poles (32) in the brushless motor (201) independently. The brushless motor controller system utilizes distributed motor controllers (203), batteries (204) and chargers (205) for brushless DC motor (201) which provides not only flexibility in motor output control but also redundancies of the controlling system making it more robust.

### TECHNICAL FIELD This invention relates to a brushless motor and a system thereof, in particular a brushless motor with flexible output power.

### BACKGROUND ART

Permanent magnet brushless motors have been widely used in various electrical applications such as three-phase pumps, fans, blowers, compressors, conveyor drives, etc. The drive power of the brushless motor is provided by the cutting effect of the permanent magnetic field from the permanent magnet and the variable electromagnetic field generated by coils or so called windings in the brushless motors. Compared to brushed motors, brushless motors as they contain no brush/commutator assembly provides higher efficiency, and reliability due to elimination of ionizing sparks from the commutators, A magnetic sensitive Hall effect component is installed in some brushless motors to collect signals of the permanent magnetic field, which are used as a reference for controlling the electrical power supplied to the windings of the motor.

However, there are also some drawbacks associated with existing brushless motors, one of which is that controllers for high power brushless motor, such as that used in electrically driven vehicle or hybrid electric-petroleum vehicles, are difficult to manufacture, due to the reason that the controller has to bear a large current which is required for generating high power output from the motor. Consequently, the manufacturing complexity for making a controller with high-power components results in high costs which is not desirable. In addition, failure or malfunctioning of the controller leads to interruption of the operation of the whole brushless motor with no backup option.

### SUMMARY OF INVENTION

In the light of the foregoing background, it is an object of the present invention to obviate or mitigate to some degree one or more problems associated with known permanent magnet brushless motors.

The above object is met by the combination of features of the main claim; the sub-claims disclose further advantageous embodiments of the invention.

It is another object of the invention to provide an alternate brushless motor and a motor system consisted of brushless motors.

One skilled in the art will derive from the following description other objects of the invention. Therefore, the foregoing statements of object are not exhaustive and serve merely to illustrate some of the many objects of the present invention.

Accordingly, the present invention in one aspect discloses a brushless motor controller system, including a brushless motor which further contains a rotor and a stator, a plurality of independent motor controllers, a plurality of batteries, and a plurality of battery chargers. The stator of the brushless motor has a plurality of salient poles. A plurality of coils is wound on the plurality of salient poles such that on each of the plurality of salient poles there are wound different groups of windings electrically isolated from each other. The plurality of independent motor controllers each corresponds and electrically connected to one of the groups of windings on one the salient pole of the brushless motor. The plurality of batteries each is connected to a corresponding one of the independent motor controllers to provide electrical power thereto. The plurality of battery chargers each is connected to a corresponding one of the batteries. The plurality of independent motor controllers each is adapted to power and control a corresponding one of the groups of coils on one the salient pole in the brushless motor independently.

Preferably, the brushless motor also contains a plurality of sensing components configured to detect status of the rotor of the brushless motor.

Preferably, the sensing components are Hall sensors. The sensing components are configured such that each the sensing component detects a rotary orientation or position of the rotor in a different phase.

In one implementation, the status detected by at least one of the sensing components is shared by more than one of the plurality of independent motor controllers.

Preferably, the brushless motor in the motor controlling system is a three-phase brushless DC motor.

In an exemplary embodiment, the plurality of independent motor controllers are adapted to shut down one or more of the groups of coils in the brushless motor so that the brushless motor operates in a deducted power output mode.

In another aspect of the present invention, a method for controlling a brushless motor contains the steps of charging a plurality of batteries through a plurality battery chargers; supplying, from each one of the plurality of batteries, electrical power to a corresponding independent motor controller among a plurality of the independent motor controllers; and controlling a respective groups of windings in a brushless motor by each one of the independent motor controllers.

Preferably, in the method above the brushless motor further contains a plurality of sensing components configured to detect status of a rotor of the brushless motor.

Preferably, the sensing components are Hall sensors. The above method further includes the steps of detecting, by each sensing components, a rotary orientation or position of the rotor of the motor in a different phase; and transmitting information containing the rotary orientation or position of the rotor detected by one the sensing component to more than one the independent motor controllers.

In one implementation, the brushless motor in the above method is a three-phase brushless DC motor.

Preferably, in the method mentioned above the plurality of independent motor controllers are adapted to shut down one or more of the groups of windings in the brushless motor so that the brushless motor operates in a deducted power output mode.

There are many advantages to the present invention. Firstly, by inserting the permanent magnets into the cavities under the surface of the rotor core, the permanent magnets are steadily fixed within the rotor, as a result of which the risk of permanent magnet detachment is eliminated or substantially reduced. On the other side, the lines of magnetic force around the rotor are distributed more evenly due to the positions of the permanent magnets, which improve the energy conversion efficiency and in turn increase the overall performance of the electric motor. Grooves are provided between two magnetized surfaces or essentially two permanent magnets on the rotor. The grooves on the rotor generate air flow when the electric brushless motor is operating, so that heat accumulated in or around the coils on the salient poles and around the motor can be effectively dissipated.

Another advantage of the present invention is that in the motor system as described in embodiments of the present invention there are provided a variety of structures such as more than one controller separately controlling the coils on the stator, or more than one controller separately controlling brushless motors in the motor system. These structures have been adopted to separately control the coils / motors in the system, so that flexible power output of the motor system can be realized, and it is much simpler to manufacture more than one small power controller rather than a single high power controller, while the desired high drive power output could still be achieved. On the other hand, the motor system is capable of achieve energy-saving when the target device does not require the full output power of the motor system.

### BRIEF DESCRIPTION OF FIGURES

The foregoing and further features of the present invention will be apparent from the following description of preferred embodiments which are provided by way of example only in connection with the accompanying figures, of which:

FIG. 1a is a cross-sectional view of the stator and rotor structure of a brushless motor according to one embodiment of the present invention.

FIG. 1b shows the cross-sectional view of the rotor of the brushless motor in FIG. 1a.

FIG. 2 is a schematic diagram showing the cross-sectional view of the brushless motor according to another embodiment of the present invention.

FIG. 3 is a schematic diagram showing the lines of magnetic fields around the rotor of a brushless motor according to one embodiment of the present invention.

FIG. 4 is a schematic diagram showing a brushless motor in which two different coils are winded on a single salient pole according to one embodiment of the present invention.

FIG. 5 is an illustration of a motor controller system according to one embodiment of the present invention.

FIG. 6 is an illustration of the Hall sensor signal feedback connection of the motor controller system in FIG. 5.

### DETAILED DESCRIPTION OF THE PREFERRED EMBODIMENTS

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

As used herein and in the claims, “couple” or “connect” refers to electrical coupling or connection either directly or indirectly via one or more electrical means unless otherwise stated.

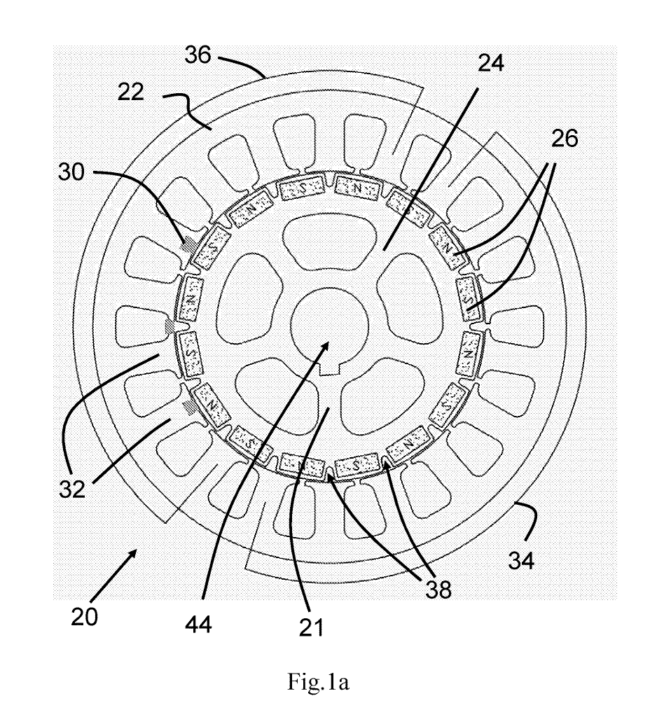

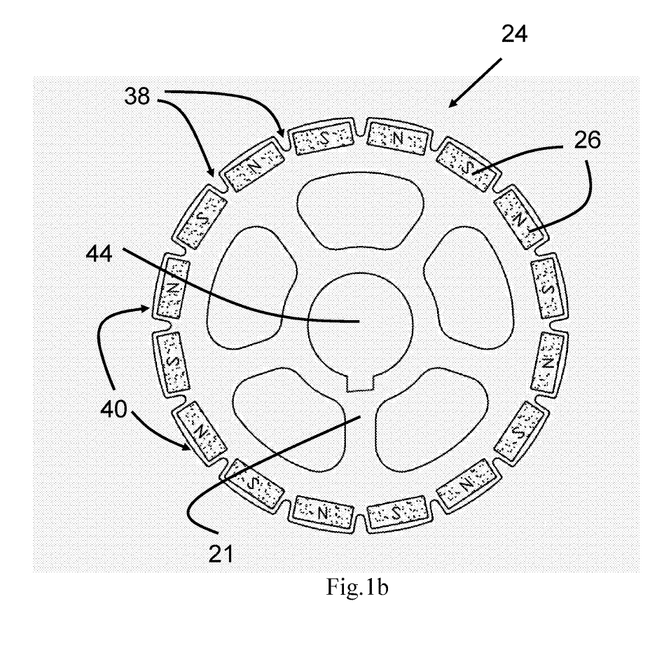

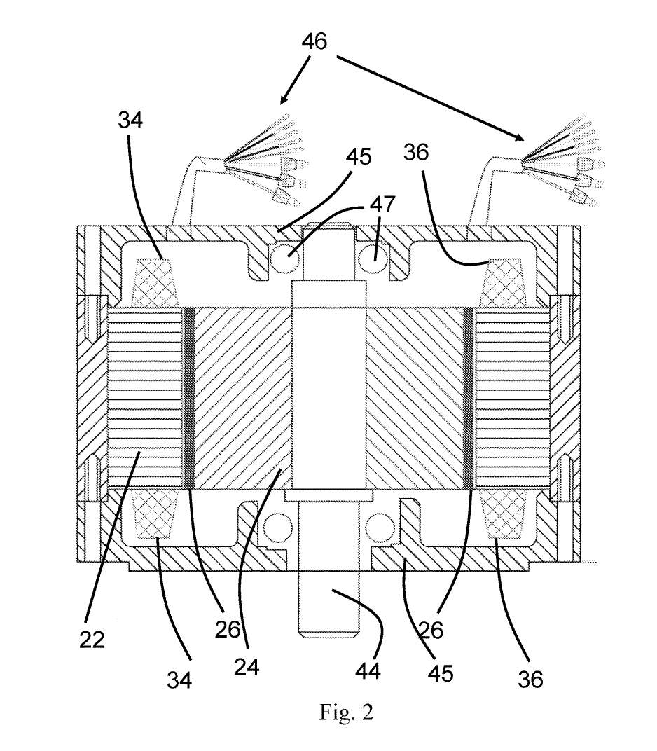

Referring now to FIGS. 1a, 1b and 2, the first embodiment of the present invention is a brushless motor which consists of a stator 22 and a rotor 24. The core 21 of the rotor 24 is preferably manufactured by stacking multiple silicon steels, and the rotor core 21 has a hollow shape through which a shaft 44 is mounted. As shown in FIG. 2, the shaft 44 is rotatably mounted on the end covers 45 of the motor via a plurality of bearings 47. On the outer circumference of the rotor 24, there is a plurality of surfaces 40, underneath each of which a cavity is formed in the rotor 24. In each cavity, there is a magnetic body 26, and preferably a magnetic steel in a bar shape disposed. The magnetic steels 26 are placed as their N and S poles are alternatively oriented in a rotational direction along the circumference of the rotor 24. The magnetic steel 26 preferably contains a silicon steel sheet (not shown). In this configuration, each surface 40 is magnetized by the corresponding magnetic steel 26 directly underneath the surface 40. The surfaces 40 thus become magnetized surfaces also alternately magnetized as N and S poles in a rotational direction. Preferably, the cavities and corresponding magnetic steels 26 are evenly distributed on the circumference of the rotor 24 and equidistant to each other at predetermined intervals. In another preferred embodiment, there is a groove 38 formed between every two magnetized surfaces 40, in other words every two magnetic steels 26 are separated by a groove 38.

On the inner circumference of the stator 22, there are formed a plurality of salient poles 32 on each of which a coil (not shown) is wound. The plurality of salient poles 32 opposite to the magnetized surfaces 40 on the rotor 24. In one embodiment, the number of salient poles 32 on the stator 22 is an even number. Preferably, the salient poles 32 are evenly distributed on the inner circumference of the stator 24 and equidistant to each other at predetermined intervals. Optionally, there are also one or more Hall effect sensors 30 installed on the salient poles 32.

In the embodiment as shown in Fig. la, there are 18 salient poles 32 on the inner circumference of the stator 22, and correspondingly 16 magnetic steels 26 on the outer circumference of the rotor 24. The 18 salient poles 32 are equally divided into two groups of three-phase windings along the inner circumference of the stator 22, namely the first winding 34 and the second winding 36. In other words, each one of the first winding 34 and the second winding 36 contains 9 salient poles. Both the first winding 34 and the second winding 36 are full-pitch windings, which means that in each three-phase winding containing 9 salient poles, a first-phase coil winds in the positive direction around a first salient pole, then winds one extra turn in the negative direction around a third salient pole, and then exits from a second salient pole between the first salient pole and the third salient pole; a second-phase coil winding in the positive direction around a fourth salient pole, then winding one extra turn in the negative direction around a sixth salient pole, and then exiting from a fifth salient pole between the fourth salient pole and the sixth salient pole; a third-phase coil winding in the positive direction around a seventh salient pole, then winding one extra turn in the negative direction around a ninth salient pole, and then exiting from a eighth salient pole between the seventh salient pole and the ninth salient pole. The same coils configuration applies to the other three-phase winding. As shown in FIG. 2, each of the three-phase windings in the motor is coupled to a cable assembly 46 which serves the purpose of supplying electricity to the windings as well as providing status information of the motor such as the data collected by the Hall sensors 30 to an external controller (not shown).

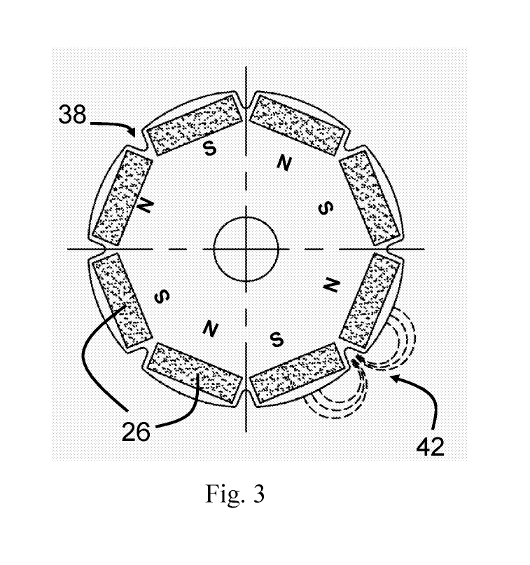

Now turning to the operation of the device described above, the brushless motor as shown in FIG. 1a, 1b and 2 is a three-phase brushless motor. When a three-phase DC electricity power is provided to the motor, the winding on the salient poles of the motor would generate electro-magnetic fields, which act with the magnetic fields generated by the permanent magnetic bodies on the rotor, and thus the rotor is driven to rotate, resulting in the output of mechanical power via the shaft. As the magnetic steels 26 are embedded inside the rotor 24, when the rotor 24 is rotating in a high speed the magnetic steels 26 are steadily fixed in the rotor 24 instead of detaching from the rotor 24 as that would happen in a traditional brushless motor. Therefore, the reliance of the motor and is greatly enhanced and the need for maintenance of the motor may be reduced. On the other side, the lines of magnetic force around the rotor are distributed more evenly due to the positions of the magnetic steels, which improves the energy conversion efficiency and in turn increase the overall performance of the electric motor. Referring to FIG. 3 which shows the lines of magnetic fields 42 near the surface of the rotor, since every two magnetic steels 26 are separated by a groove 38, the magnetic field near the surface of the rotor is further distributed in an even way compared to traditional motors without the groove. The hysteresis loops of the magnetic steels are also enhanced as a result of the separation between two magnetic steels, and the surface magnetic field of the rotor is strengthened. On the other hand, the groove 38 due to its uneven geometrical shape also serves the purpose of generating air flow when the rotor 24 is rotating, therefore facilitating the heat dissipation of the windings within the motor and maintaining the temperature of the motor when it is in operation.

The silicon steel sheet inserted into the magnetic steel 26 protects the magnetic steel 26 from magnetic field leakage. The Hall effect sensors or in short Hall sensors 30 installed on the salient poles 32 of the brushless motor detects the position as well as the rotating speed of the rotor 24 and feed that information to an external motor controller (not shown) connected to the motor via the cable assembly 46 as mentioned above. Mounting more than one Hall effect sensors 30 on the corresponding salient poles 32 provides better detection results to the Hall effect sensors 30 as the magnetic fields would be detected at different places. Preferably, the Hall effect sensors 30 are also divided into three groups to provide status information for each phase of the three-phase motor. The output of the Hall effect sensors 30 provided to the remote motor controller may be further analyzed using computer software.

Further, the salient poles in the above embodiments of the motor are equally divided into two groups of three-phase windings, and each three-phase winding may be connected to a separate motor controller, which means that the total electrical current bear by the brushless motor is also equally shared by the two motor controller. This composite magnetic flux configuration eliminates the need of producing a single, high-power motor controller, but instead it is much simpler to manufacture more than one small power controllers to control the motor, while the desired high drive power output of the motor could still be achieved. As there is more than one motor controller, the total current supplied to the motor is flexible and could be adjusted depending on a specific application, such as where a high output torque is required.

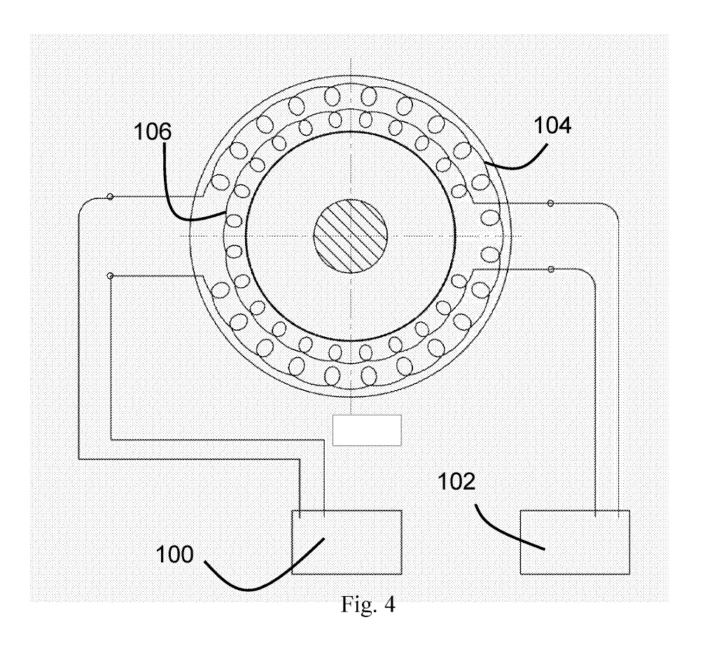

In another embodiment of the present invention as shown in FIG. 4, the brushless motor on each of its salient poles contains two different coils wound, namely the first coil 104 and second coil 106. The first coil 104 and second coil 106 are independent and isolated to each other. The first coil 104 and second coil 106 are connected by electric wires to a first controller 100 and a second control 102, respectively.

In operation, as the first coil 104 and second coil 106 are independent to each other, the brushless motor as shown is capable of providing electric power only to the first coil 104, second coil 106, or both. For instance, when the target device only requires a relatively small driving force, the first controller 100 may provide electricity to the first coil 104, and the magnetic fields generated by the first coil 104 and the rotor drive the shaft of the motor to rotate, in order to produce a relatively small driving force. At this time the second coil 106 is not supplied with electricity and thus there is no magnetic field generated by the second coil 106. On the other hand, when the target device requires a relatively large driving force, then both the first controller 100 and the second controller 102 may provide electricity to the first coil 104 and the second coil 106 at the same time. The rotor then reacts with both the magnetic fields from the first coil 104 and the second coil 106, and thus the total driving force outputted by the motor is large.

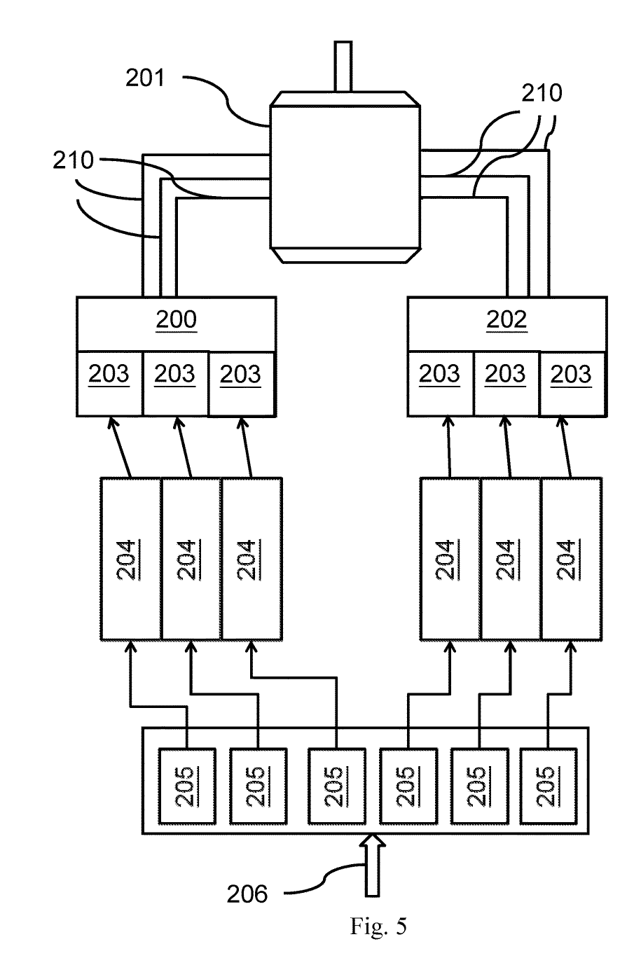

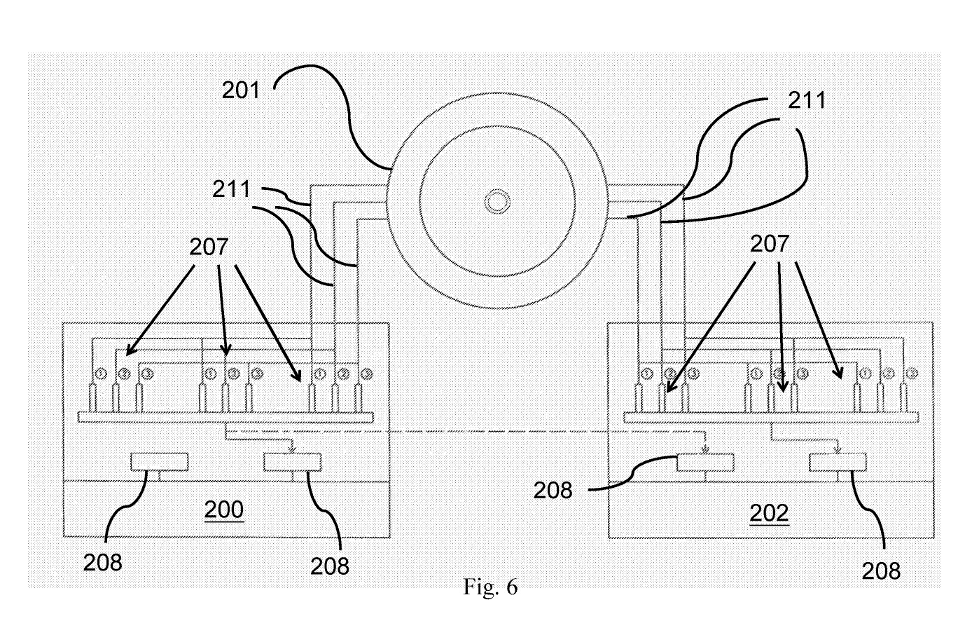

The brushless motor according to the present invention may further be implemented to contain similar structures as that described in FIG. 4, but with the difference that the brushless motor on each of its salient poles contains more than two different groups of windings. For example, in one implementation of the brushless motor 201 as shown in FIGS. 5 and 6, there are six sets of independent coils on salient poles of the brushless motor (not shown). A set of independent coil is also referred as a group of windings in this description. In other words, the brushless motor can be viewed as six independent motors encapsulated in a common motor housing. Each of the independent motor is a three phase brushless DC motor. FIG. 5 shows a brushless DC motor controlling system according to one embodiment of the present invention. In FIG. 5, for each of the sets of independent coils in motor 201, there is a separate control line 210 connecting the same to one of the main controllers 200 or 202, and each control line 210 is further consisted of three wires (not shown) corresponding to three phases of one set of coils. The main controller 200 and 202 in FIG. 5 are therefore each connected with total nine wires from the motor 201.

Referring now to the main controllers 200 and 202, each of them further contains three independent controllers 203 that are accommodated in a single device housing of the controller 200 or 202. Each of the independent controllers 203 correspond and electrically connected to a respective battery 204 that is placed outside of the main controller 200 or 202. As shown in FIG. 5, each of the batteries 204 is further connected to respective battery charger 205. The battery charger 205 may be commonly or separately connected to an external power supply such as the 110V/220V supply main.

Turning to FIG. 6, which shows an additional signal feedback connection between the main controllers 200, 202 and the motor 201. Similar to the motor described in FIG. 1, the motor 201 in FIG. 6 is also configured with a plurality of Hall sensors (not shown). The Hall sensor is a type of sensing components referred in this description. The Hall sensors in motor 201 are arranged on the stator to detect rotatory orientations or positions of the rotor for each of the independent sets of coils. As shown in FIG. 6, there are three Hall sensors connected to the main controller 202, and another three Hall sensors connected to the other main controller 200. Accordingly, there are in total six different pieces of Hall sensors in the motor 201 in FIGS. 5 and 6. Each one of the Hall sensors is connected to a respective pin of a socket 207 in the main controllers 200 and 202. Note that in FIG. 6, for instance one Hall sensor (not shown) is connected to Pin No. 1 of three sockets 207 in the main controller 200 via a common signal line 211. The reason for such configuration is that each Hall sensor is responsible for detecting the rotor position in one phase, no matter how many independent sets of coils are configured in the motor. In other words, the rotor position information detected by one Hall sensor may be shared by more than one controller to control respective sets of independent coils. Even if the output data of a Hall sensor is identical, the same information can be used to calculate relative position of the rotor to each different set of independent coils since these coils are mounted on the stator and their angular positions are fixed and known. In the motor controlling system shown in FIG. 6, each Hall sensor's output is transmitted to three independent controllers in the main controllers 202 and 200. Therefore, the Hall sensor's output is shared by the three independent controllers to indicate the rotor position in one of the three phases.

In the configuration shown in FIG. 6 the three sockets 207 in main controller 202 or 200 are selectively connected to one of the two interfaces 208 in the main controller. The interface 208 is used to transmit collected motor status information from the Hall sensors to other components in the main controller such as the independent controllers mentioned above. For example the collected motor status information may be transmitted to a microprocessor in one independent controller. The three sockets 207 are connected to one of the two interfaces 208 at a time, where the other unused interface 208 is mainly used for backup purpose or providing additional data interface in case the sensor data has to be provided to other data processing modules beside the independent controllers.

Now turning to the operation of the motor controlling system described above, the motor controller system receives external AC power from an external power input 206 such as a power cable connected to 110V/220V AC electricity. The AC power is then provided to the plurality of battery chargers 205 which covert the AC electricity to DC power and charge the batteries 204 on a one-to-one basis. Each of the batteries 204 is adapted to drive its corresponding independent motor controller 203 which in turn drives a corresponding set of independent coils in the motor 201. The six independent controllers 203 can individually controls its counterpart set of coils in the motor 201, so that different power output achieved by the six set of independent coils in the motor 201 as a whole can be achieved. For example, in a lower power output application each of the motor independent controllers 203 may only outputs a small amount of current. Alternatively, the plurality of independent motor controllers 203 are adapted to shut down one or more of the sets of coils in the brushless motor 201 so that the brushless motor operates in a deducted power output mode. In contrast, when the motor 201 is required to operate in a full throttle condition, each of the independent controllers 203 outputs a maximum allowed amount to their corresponding coil windings so that the total power output achieved by the motor 201 is maximum.

One exemplary application of the brushless DC motor controller system illustrated in

FIGS. 5 and 6 is for an electric vehicle or a hybrid electric-petroleum vehicle that is driven by battery power. Advantages provided by the motor controller system according to the present invention are that instead of configuring a single, bulky controller, a plurality of smaller, independent controllers may now be implemented which provides much lower difficulties and costs in manufacturing the controllers, since as mentioned above building a motor controller handling smaller power is much more cost effective compared to making a motor controller handling power. More importantly, the multiple independent controllers instead of a single high power controller provide redundancies in case of motor controller failure, which is vital to normal operation of the brushless DC motor especially in electric vehicles where malfunctioning of the electric motor may lead to great danger to the vehicle and other road users. In the configuration shown in FIG. 5, even if one of the independent controllers 203 is out of function, the motor 201 is still able to operate although at a less power output, since the other five sets of independent coils are still operating. This affected operation may continue even if additional independent controllers 203 become inoperative as long as not all independent controllers 203 are malfunctioning. Therefore, the distributed motor structure and its controllers in FIG. 5 not only provide flexibilities in controlling the motor as a whole, but also provide additional measure for maintaining reliability. The same principle applies to the plurality of batteries 204 and battery chargers 205. By having multiple small, independent batteries and associated battery chargers in the system, the run-out or malfunctioning of one battery would not lead to complete stop of operation of the brushless motor since other batteries are still able to provide power to some sets of coils in the brushless motor.

Another advantage of the distributed motor controllers, batteries and batteries controllers in the field of electrically driven vehicles is that these components are now produced to be discrete parts, which means that they can be separated from each other to be placed into different locations of the vehicle. This provides much more design freedoms to the vehicle designers so they do not have to consider reserving a large inner space of the vehicle for storing the motor controller or the battery. Instead, following the desired aesthetic design of the vehicle body the individual batteries and motor controllers can be placed at different locations so that the performance of the power system of the vehicle is not compromised but at the same time the components can be distributed to save space and conform to the overall contour of the vehicle.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

It is to be understood that, if any prior art publication is referred to herein, such reference does not constitute an admission that the publication forms a part of the common general knowledge in the art, in Australia or any other country.

For example, the permanent magnetic bodies in the brushless motor are magnetic steels with silicon steel sheet inserted in the magnetic steels. The rotor core of the motor is made of a stack of silicon steel sheets. However, one skilled in the art should realize that the magnetic bodies or the rotor core may be fabricated using any other suitable materials/configurations, as long as these materials/configurations are capable of providing the desired performance.

In a preferred embodiment described above there are 18 salient poles and 16 magnetic steels in the brushless motor. But in other applications, the brushless motor may contain any number of poles and magnetic bodies, provided that the number of the magnetic bodies is an even number and the commutation condition can be satisfied. In one implementation, the number of the salient poles could be an even number or an odd number, and the number of magnetic steels must be an even number.

The embodiments illustrated in FIG. 4 to FIG. 6 provide various configurations for the motor and motor system to realize flexible power output to the target device, such as multiple coils on the poles. Those skilled in the art should realize to generate different power output in specific applications, any type of configuration/combination of the motor coils shall fall within the spirit of the invention, and should not be limited by the specific embodiments described above. For example, there could be three or four distinct windings on a single pole in the motor, more than two or six groups of stators/rotors maybe installed inside a single motor.

The above embodiments were described using a brushless motor. However, one skilled in the art would appreciate that the teachings of the present invention may also be applicable to other types of motors such as brushed motors or AC synchronized motors.

In the embodiment described in FIG. 6, there are six Hall sensor elements configured in the brushless motor, where every three of them provide three phase rotary orientation/position of the rotor to a main controller. However, a skilled person in the art would realize that in the case of six sets of coils in the brushless motor, the number of Hall elements does not have to be six. For example, there can be three Hall elements only in the motor where the status information output from the Hall elements are shared every independent motor controller in the system. Alternatively, there may be for example nine Hall elements in the brushless motor for providing outputs to three main controllers, etc.

Also, in the embodiment shown in FIGS. 5 and 6, there are shown six batteries and six battery chargers, where the six batteries one-to-one correspond to the six motor independent controllers. However, in other embodiments of the present invention, there could be different configurations of the independent controllers and the batteries, for example one battery corresponds to two independent controllers, or two batteries correspond to one independent controller. Similarly, it does not necessarily require each battery charger corresponds to a battery, as one battery charger may be connected to more than one battery for example.

1. A brushless motor controller system, comprising:
a brushless motor which further comprises a rotor and a stator, said stator having a plurality of salient poles; a plurality of coils wound on said plurality of salient poles such that on each of said plurality of salient poles there is wound different groups of windings electrically isolated from each other;
a plurality of independent motor controllers each corresponds and electrically connected to one of said groups of windings on one said salient pole of said brushless motor;
a plurality of batteries each connected to a corresponding one of said independent motor controllers to provide electrical power thereto; and
a plurality of battery chargers each connected to a corresponding one of said batteries;
wherein said plurality of independent motor controllers each adapted to power and control a corresponding one of said groups of coils on one said salient pole in said brushless motor independently.

2. The brushless motor controller system according to claim 1, wherein said brushless motor further comprises a plurality of sensing components configured to detect status of said rotor of said brushless motor.

3. The brushless motor controller system according to claim 2, wherein said sensing components are Hall sensors;
said sensing components configured such that each said sensing component detects a rotary orientation or position of said rotor in a different phase.

4. The brushless motor controller system according to claim 3, wherein said status detected by at least one of said sensing components is shared by more than one of said plurality of independent motor controllers.

5. The brushless motor controller system according to claim 1, wherein said brushless motor is a three-phase brushless DC motor.

6. The brushless motor controller system according to claim 1, wherein said plurality of independent motor controllers are adapted to shut down one or more of said groups of coils in said brushless motor so that said brushless motor operates in a deducted power output mode.

7. A method for controlling a brushless motor, comprising the steps of:
charging a plurality of batteries through a plurality battery chargers;
supplying, from each one of said plurality of batteries, electrical power to a corresponding independent motor controller among a plurality of said independent motor controllers; and
controlling a respective groups of windings in a brushless motor by each one of said independent motor controllers.

8. The method of claim 7, wherein said brushless motor further comprises a plurality of sensing components configured to detect status of a rotor of said brushless motor.

9. The method of claim 8, wherein said sensing components are Hall sensors; said method further comprises:
detecting, by each sensing components, a rotary orientation or position of said rotor of said motor in a different phase; and
transmitting information containing said rotary orientation or position of said rotor detected by one said sensing component to more than one said independent motor controllers.

10. The method according to claim 7, wherein said brushless motor is a three-phase brushless DC motor.

11. The method according to claim 7, wherein said plurality of independent motor controllers are adapted to shut down one or more of said groups of windings in said brushless motor so that said brushless motor operates in a deducted power output mode.
